(19) United States
(12) Patent Application Publication
(10) Pub. No.: US 2014/0085583 A1
(43) Pub. Date: Mar. 27, 2014

(54) DISPLAY PANEL

(71) Applicant: Au Optronics Corporation, Hsinchu (TW)

(72) Inventors: Mei-Ju Lu, Kaohsiung City (TW); Cho-Yan Chen, Taichung City (TW); Kuan-Yu Chen, Taipei City (TW); Sau-Wen Tsao, Taipei City (TW); Yen-Ying Kung, New Taipei City (TW); Tien-Lun Ting, Taichung City (TW)

(73) Assignee: Au Optronics Corporation, Hsinchu (TW)

(21) Appl. No.: 13/900,529

(22) Filed: May 22, 2013

(30) Foreign Application Priority Data
Sep. 26, 2012 (TW) 101135353

(51) Int. Cl. G02F 1/1343

(52) U.S. Cl. CPC G02F 1/134309
USPC 349/141

(57) ABSTRACT

A display panel includes a pixel structure that has first, second, and third sub-pixels. In the first sub-pixel, a first pixel electrode having first branches and a second pixel electrode having second branches are alternately arranged. Gap dB is defined between adjacent first and second branches. In the second sub-pixel, a third pixel electrode having third branches and a fourth pixel electrode having fourth branches are alternately arranged. Gap dG is defined between adjacent third and fourth branches. In the third sub-pixel, a fifth pixel electrode having fifth branches and a sixth pixel electrode having sixth branches are alternately arranged. Gap dR is defined between adjacent fifth and sixth branches. The gaps dB, dG, and dR at least include minimum gaps dBₘᵢₙ, dGₘᵢₙ, and dRₘᵢₙ and gaps dBₙ, dGₙ, and dRₙ, respectively. Here, dGₙ is equal to dRₙ, and (1/dBₙ)≧[(1/dRₙ)*1.1].

### CROSS-REFERENCE TO RELATED APPLICATION

This application claims the priority benefit of Taiwan application serial no. 101135353, filed on Sep. 26, 2012. The entirety of the above-mentioned patent application is hereby incorporated by reference herein and made a part of this specification.

### BACKGROUND OF THE INVENTION

1. Field of the Invention

The invention relates to a panel. More particularly, the invention relates to a display panel.

2. Description of Related Art

Nowadays, the market demands a liquid crystal display (LCD) panel to develop its functions of high contrast ratio, no gray scale inversion, little color shift, high luminance, full color, high color saturation, fast response, wide viewing angle, etc. Currently, the technologies capable of fulfilling the wide-viewing-angle demand include a twist nematic (TN) LCD panel with a wide viewing film, an in-plane switching (IPS) LCD panel, a fringe field switching (FFS) LCD panel, a multi-domain vertically aligned (MVA) LCD panel, and so on.

In a conventional vertically arranged type LCD panel that is subject to the optical properties of liquid crystal molecules, the issue of color shift or insufficient color saturation may occur when a viewer watches the LCD panel at different viewing angles. This is the so-called “color washout”. Although various solutions to the issue of color shift or insufficient color saturation have been proposed to solve the color washout problem, these solutions may bring about another color shift problem, i.e., when an image is viewed at a front angle and at a side angle, the image viewed at the side angle may be bluish, greenish, or a reddish in comparison with the image viewed at the front angle, and thereby the color of the image observed by the viewer is not vivid enough.

### SUMMARY OF THE INVENTION

The invention is directed to a display panel capable of correcting color shift of an image viewed at a side angle in comparison with an image viewed at a front angle.

In an embodiment of the invention, a display panel that includes a pixel structure is provided. The pixel structure includes a first sub-pixel, a second sub-pixel, and a third sub-pixel. The first sub-pixel is disposed in a first sub-pixel area and includes a first pixel electrode and a second pixel electrode. The first pixel electrode includes a plurality of first branches, the second pixel electrode includes a plurality of second branches, and the first branches and the second branches are alternately arranged in parallel. Here, a gap between one of the first branches and an adjacent one of the second branches is defined as dB, and the gaps dBs at least include a minimum gap dBₘᵢₙ and a N^{th} gap dBₙ sequentially arranged. The second sub-pixel is disposed in a second sub-pixel area and includes a third pixel electrode and a fourth pixel electrode. The third pixel electrode includes a plurality of third branches, the fourth pixel electrode includes a plurality of fourth branches, and the third branches and the fourth branches are alternately arranged in parallel. Here, a gap between one of the third branches and an adjacent one of the fourth branches is defined as dG, and the gaps dGs at least include a minimum gap dGₘᵢₙ and a N^{th} gap dGₙ sequentially arranged. The third sub-pixel is disposed in a third sub-pixel area and includes a fifth pixel electrode and a sixth pixel electrode. The fifth pixel electrode includes a plurality of fifth branches, the sixth pixel electrode includes a plurality of sixth branches, and the fifth branches and the sixth branches are alternately arranged in parallel. Here, a gap between one of the fifth branches and an adjacent one of the sixth branches is defined as dR, the gaps dRs at least include a minimum gap dRₘᵢₙ and a N^{th} gap dRₙ sequentially arranged, wherein the N^{th} gap dGₙ in the second sub-pixel is equal to the N^{th} gap dRₙ in the third sub-pixel, and (1/dBₙ)≧[(1/dRₙ)*1.1].

In an embodiment of the invention, another display panel that includes a pixel structure is provided. The pixel structure includes a first sub-pixel, a second sub-pixel, and a third sub-pixel. The first sub-pixel is disposed in a first sub-pixel area and includes a first pixel electrode and a second pixel electrode. The first pixel electrode includes a plurality of first branches, the second pixel electrode includes a plurality of second branches, and the first branches and the second branches are alternately arranged in parallel. Here, a gap between one of the first branches and an adjacent one of the second branches is defined as dB, and the gaps dBs are not completely equal to one another and include a maximum gap dBₘₐₓ. The second sub-pixel is disposed in a second sub-pixel area and includes a third pixel electrode and a fourth pixel electrode. The third pixel electrode includes a plurality of third branches, the fourth pixel electrode includes a plurality of fourth branches, and the third branches and the fourth branches are alternately arranged in parallel. Here, a gap between one of the third branches and an adjacent one of the fourth branches is defined as dG, and the gaps dGs are not completely equal to one another and include a maximum gap dGₘₐₓ. The third sub-pixel is disposed in a third sub-pixel area and includes a fifth pixel electrode and a sixth pixel electrode. The fifth pixel electrode includes a plurality of fifth branches, the sixth pixel electrode includes a plurality of sixth branches, and the fifth branches and the sixth branches are alternately arranged in parallel. Here, a gap between one of the fifth branches and an adjacent one of the sixth branches is defined as dR, the gaps dRs are not completely equal to one another and include a maximum gap dRₘₐₓ, wherein dRₘₐₓ≦dGₘₐₓ<dBₘₐₓ, 5 μm>(dGₘₐₓ−dRₘₐₓ)≧0 μm, and 5 μm>(dBₘₐₓ−dGₘₐₓ)≧1 μm.

In view of the above, the pixel electrodes in the sub-pixels may have various gaps, and the relationship of the gaps among the pixel electrodes in the sub-pixels may be adjusted, so as to correct the color shift of an image viewed at a side angle. As such, display quality of the display panel may be improved.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic top view illustrating a display panel according to an embodiment of the invention.

FIG. 2 is a schematic top view illustrating a display panel according to an embodiment of the invention.

FIG. 3 is a schematic chart illustrating voltage-transmittance (V-T) curves of blue, green, and red light.

### DETAILED DESCRIPTION OF DISCLOSED EMBODIMENTS

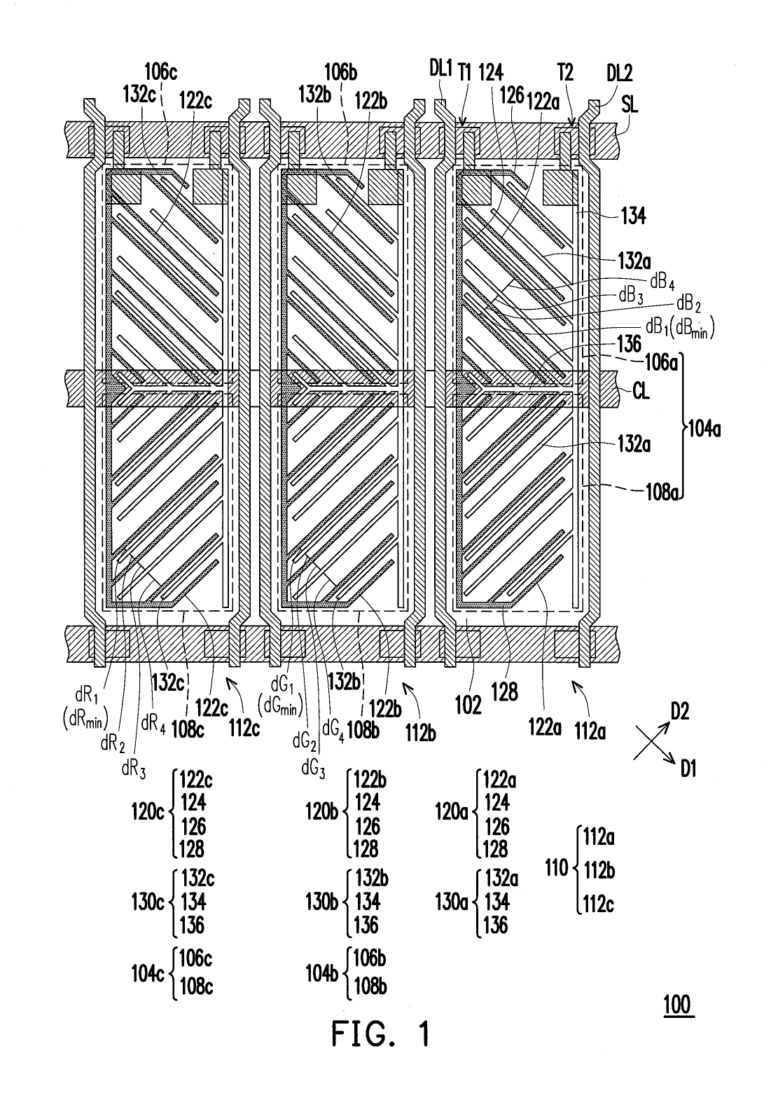

FIG. 1 is a schematic top view illustrating a display panel according to an embodiment of the invention. With reference to FIG. 1, the display panel 100 includes a substrate 102 and a pixel structure 110. The substrate 102 includes a first sub-pixel area 104a, a second sub-pixel area 104b, and a third sub-pixel area 104c, for instance. The pixel structure 110 is disposed on the substrate 102 and includes a first sub-pixel 112a, a second sub-pixel 112b, and a third sub-pixel 112c. In general, the display panel 100 further includes a color filter array (not shown) that includes a first color filter pattern, a second color filter pattern, and a third color filter pattern. The pixel structure 110 and the color filter array are correspondingly arranged. For instance, the first sub-pixel 112a and the first color filter pattern are correspondingly arranged, the second sub-pixel 112b and the second color filter pattern are correspondingly arranged, and the third sub-pixel 112c and the third color filter pattern are correspondingly arranged. According to the present embodiment, if the first color filter pattern, the second color filter pattern, and the third color filter pattern are respectively blue, green, and red filter patterns, the first, second, and third sub-pixels 112a, 112b, and 112c are respectively blue sub-pixel, green sub-pixel, and red sub-pixel.

The first sub-pixel 112a is disposed in the first sub-pixel area 104a and includes a first pixel electrode 120a and a second pixel electrode 130a. The first pixel electrode 120a includes a plurality of first branches 122a, the second pixel electrode 130a includes a plurality of second branches 132a, and the first branches 122a and the second branches 132a are alternately arranged in parallel. Here, a gap between one of the first branches 122a and an adjacent one of the second branches 132a is defined as dB, and the gaps dBs at least include a minimum gap dBₘᵢₙ and a N^{th} gap dBₙ that are sequentially arranged. In the present embodiment, the first sub-pixel 112a further includes a M^{th} gap dBₘ, for instance, dBₘ≧dBₘᵢₙ, and the M^{th} gap dBₘ is adjacent to the N^{th} gap dBₙ. Here, the gaps dBs at least include the minimum gap dBₘᵢₙ, the M^{th} gap dBₘ, and the N^{th} gap dBₙ that are sequentially arranged. If dBₘᵢₙ=dBₘ, then dBₙ>dBₘ; if dBₘ>dBₘᵢₙ, then dBₘ≠dBₙ.

The condition “if dBₘᵢₙ=dBₘ, then dBₙ>dBₘ” is equal to the condition “dBₙ>dBₘ=dBₘᵢₙ”, and there are at least two kinds of gaps dBs defined between the first pixel electrode 120a and the second pixel electrode 130a and sequentially arranged. Here, the gaps dBs are, for instance, the M^{th} gap dBₘ (i.e., the minimum gap dBₘᵢₙ), the N^{th} gap dBₙ, . . . that are sequentially arranged in size, e.g., the first gap dB₁ (i.e., the minimum gap dBₘᵢₙ), the second gap dB₂, and so on. Given the same condition, there may be only two kinds of gaps dBs defined between the first pixel electrode 120a and the second pixel electrode 130a, i.e., the first gap dB (i.e., the minimum gap dBₘᵢₙ) and the second gap dB₂ that are sequentially arranged in size.

By contrast, the condition “if dBₘ>dBₘᵢₙ, then dBₘ≠dBₙ” is equal to the condition “dBₘ>dBₘᵢₙ, dBₙ>dBₘᵢₙ, and dBₘ≠dBₙ”, and there are at least three kinds of gaps dBs defined between the first pixel electrode 120a and the second pixel electrode 130a. Here, the gaps dBs are, for instance, the minimum gap dBₘᵢₙ, the N^{th} gap dBₙ, the M^{th} gap dBₘ, . . . that are sequentially arranged in size, e.g., the first gap dB₁ (i.e., the minimum gap dBₘᵢₙ), the second gap dB₂, the third gap dB₃, and so on. Given the same condition, there may be only three kinds of gaps dBs defined between the first pixel electrode 120a and the second pixel electrode 130a, i.e., the first gap dB₁ (i.e., the minimum gap dBₘᵢₙ), the second gap dB₂, and the third gap dB₃ that are sequentially arranged in size.

In the present embodiment, there are four exemplary gaps dBs defined between the first pixel electrode 120a and the second pixel electrode 130a, i.e., the first gap dB₁ (i.e., the minimum gap dBₘᵢₙ), the second gap dB₂, the third gap dB₃, and the fourth gap dB₄ that are sequentially arranged in size, and dB₁ (=dBₘᵢₙ)<dB₂<dB₃<dB₄. Here, the gaps dBs include 4 μm (dBₘᵢₙ, dB₁), 7 μm (dB₂), 11 μm (dB₃), and 16 μm (dB₄) that are sequentially arranged, for instance.

The second sub-pixel 112b is disposed in a second sub-pixel area 104b and includes a third pixel electrode 120b and a fourth pixel electrode 130b. The third pixel electrode 120b includes a plurality of third branches 122b, the fourth pixel electrode 130b includes a plurality of fourth branches 132b, and the third branches 122b and the fourth branches 132b are alternately arranged in parallel. Here, a gap between one of the third branches 122b and an adjacent one of the fourth branches 132b is defined as dG, and the gaps dGs at least include a minimum gap dGₘᵢₙ and a N^{th} gap dGₙ that are sequentially arranged. In the present embodiment, the second sub-pixel 112b further includes a M^{th} gap dGₘ, for instance, dGₘ≧dGₘᵢₙ, and the M^{th} gap dGₘ is adjacent to the N^{th} gap dGₙ. Here, the gaps dGs at least include the minimum gap dGₘᵢₙ, the M^{th} gap dGₘ, and the N^{th} gap dGₙ that are sequentially arranged. If dGₘᵢₙ=dGₘ, then dGₙ>dGₘ; if dGₘ>dGₘᵢₙ, then dGₘ≠dGₙ.

The condition “if dGₘᵢₙ=dGₘ, then dGₙ>dGₘ” is equal to the condition “dGₙ>dGₘ=dGₘᵢₙ”, and there are at least two kinds of gaps dGs defined between the third pixel electrode 120b and the fourth pixel electrode 130b. Here, the gaps dGs are, for instance, the M^{th} gap dGₘ (i.e., the minimum gap dGₘᵢₙ), the N^{th} gap dGₙ, . . . that are sequentially arranged in size, e.g., the first gap dG₁ (i.e., the minimum gap dGₘᵢₙ), the second gap dG₂, and so on. Given the same condition, there may be only two kinds of gaps dGs defined between the third pixel electrode 120b and the fourth pixel electrode 130b, i.e., the first gap dG₁ (i.e., the minimum gap dGₘᵢₙ) and the second gap dG₂ that are sequentially arranged in size.

By contrast, the condition “if dGₘ>dGₘᵢₙ, then dGₘ≠dGₙ” is equal to the condition “dGₘ>dGₘᵢₙ, dGₙ>dGₘᵢₙ, and dGₘ≠dGₙ”, and there are at least three kinds of gaps dGs defined between the third pixel electrode 120b and the fourth pixel electrode 130b. Here, the gaps dGs are, for instance, the minimum gap dGₘᵢₙ, the N^{th} gap dGₙ, the M^{th} gap dGₘ, . . . that are sequentially arranged in size, e.g., the first gap dG₁ (i.e., the minimum gap dGₘᵢₙ), the second gap dG₂, the third gap dG₃, and so on. Given the same condition, there may be only three kinds of gaps dGs defined between the third pixel electrode 120b and the fourth pixel electrode 130b, i.e., the first gap dG₁ (i.e., the minimum gap dGₘᵢₙ), the second gap dG₂, and the third gap dG₃ that are sequentially arranged in size.

In the present embodiment, there are four exemplary gaps dGs defined between the third pixel electrode 120b and the fourth pixel electrode 130b, i.e., the first gap dG₁ (i.e., the minimum gap dGₘᵢₙ), the second gap dG₂, the third gap dG₃, and the fourth gap dG₄ that are sequentially arranged in size, and dG₁ (=dGₘᵢₙ)<dG₂<dG₃<dG₄. Here, the gaps dGs include 4 μm (dGₘᵢₙ, dG₁), 8 μm (dG₂), 12 μm (dG₃), and 16 μm (dG₄) that are sequentially arranged, for instance.

The third sub-pixel 112c is disposed in a third sub-pixel area 104c and includes a fifth pixel electrode 120c and a sixth pixel electrode 130c. The fifth pixel electrode 120c includes a plurality of fifth branches 122c, the sixth pixel electrode 130c includes a plurality of sixth branches 132c, and the fifth branches 122c and the sixth branches 132c are alternately arranged in parallel. Here, a gap between one of the fifth branches 122c and an adjacent one of the fifth branches 132c is defined as dR, and the gaps dRs at least include a minimum gap dRₘᵢₙ and a N^{th} gap dRₙ that are sequentially arranged. In the present embodiment, the third sub-pixel 112c further includes a M^{th} gap dRₘ, for instance, dRₘ≧dRₘᵢₙ, and the M^{th} gap dRₘ is adjacent to the N^{th} gap dRₙ. Here, the gaps dRs at least include the minimum gap dRₘᵢₙ, the M^{th} gap dRₘ, and the N^{th} gap dRₙ that are sequentially arranged. If dRₘᵢₙ=dRₘ, then dRₙ>dRₘ; if dRₘ>dRₘᵢₙ, then dRₘ≠dRₙ. At least one of the gaps dBₙ in the first sub-pixel 112a is different from at least one of the gap dGₙ in the second sub-pixel 112b and the gap dRₙ in the third sub-pixel 112c.

The condition “if dRₘᵢₙ=dRₘ, then dRₙ>dRₘ” is equal to the condition “dRₙ>dRₘ=dRₘᵢₙ”, and there are at least two kinds of gaps dRs defined between the fifth pixel electrode 120c and the sixth pixel electrode 130c. Here, the gaps dRs are, for instance, the M^{th} gap dRₘ (i.e., the minimum gap dRₘᵢₙ), the N^{th} gap dRₙ, . . . that are sequentially arranged in size, e.g., the first gap dR₁ (i.e., the minimum gap dRₘᵢₙ), the second gap dR₂, and so on. Given the same condition, there may be only two kinds of gaps dRs defined between the fifth pixel electrode 120c and the sixth pixel electrode 130c, i.e., the first gap dR₁ (i.e., the minimum gap dRₘᵢₙ) and the second gap dR₂ that are sequentially arranged in size.

By contrast, the condition “if dRₘ>dRₘᵢₙ, then dRₘ≠dRₙ” is equal to the condition “dRₘ>dRₘᵢₙ, dRₙ>dRₘᵢₙ, and dRₘ≠dRₙ”, and there are at least three kinds of gaps dRs defined between the fifth pixel electrode 120c and the sixth pixel electrode 130c. Here, the gaps dRs are, for instance, the minimum gap dRₘᵢₙ, the N^{th} gap dRₙ, the M^{th} gap dRₘ, . . . that are sequentially arranged in size, e.g., the first gap dR₁ (i.e., the minimum gap dRₘᵢₙ), the second gap dR₂, the third gap dR₃, and so on. Given the same condition, there may be only three kinds of gaps dRs defined between the fifth pixel electrode 120c and the sixth pixel electrode 130c, i.e., the first gap dR₁ (i.e., the minimum gap dRₘᵢₙ), the second gap dR₂, and the third gap dR₃ that are sequentially arranged in size.

In the present embodiment, there are four exemplary gaps dRs defined between the fifth pixel electrode 120c and the sixth pixel electrode 130c, i.e., the first gap dR₁ (i.e., the minimum gap dRₘᵢₙ), the second gap dR₂, the third gap dR₃, and the fourth gap dR₄ that are sequentially arranged, and dR₁ (=dRₘᵢₙ)<dR₂<dR₃<dR₄. Here, the gaps dRs include 4 μm (dRₘᵢₙ, dR₁), 8 μm (dR₂), 12 μm (dR₃), and 16 μm (dR₄) that are sequentially arranged, for instance.

At least one of the gaps dBₙ in the first sub-pixel 112a is different from at least one of the gap dGₙ in the second sub-pixel 112b and the gap dRₙ in the third sub-pixel 112c. According to the present embodiment, one of the first pixel electrode 120a and the second pixel electrode 130a is coupled to a first voltage level, and the other one is coupled to a second voltage level, for instance. Similarly, one of the third pixel electrode 120b and the fourth pixel electrode 130b is coupled to a first voltage level, and the other one is coupled to a second voltage level; one of the fifth pixel electrode 120c and the sixth pixel electrode 130c is coupled to a first voltage level, and the other one is coupled to a second voltage level.

In an embodiment of the invention, at least one of the gaps dBₙ in the first sub-pixel 112a is different from at least one of the gaps dGₙ in the second sub-pixel 112b, at least one of the gaps dBₙ in the first sub-pixel 112a is different from at least one of the gaps dRₙ in the third sub-pixel 112c, or at least one of the gaps dBₙ in the first sub-pixel 112a is different from at least one of the gaps dGₙ in the second sub-pixel 112b and is different from at least one of the gaps dRₙ in the third sub-pixel 112c. That is, the design of gaps in the second sub-pixel 112b may be the same as the design of gaps in the third sub-pixel 112c, while the design of gaps in the first sub-pixel 112a is different from foresaid two designs. Alternatively, the designs of gaps in the first, second, and third sub-pixels 112a, 112b, and 112c are all different. For instance, in an embodiment, the gaps dBs in the first sub-pixel 112a are 4 μm (dB₁, dBₘᵢₙ), 7 μm (dB₂), dB₃, . . . arranged sequentially in size, the gaps dGs in the second sub-pixel 112b are 4 μm (dG₁, dGₘᵢₙ), 8 μm (dG₂), dG₃, . . . arranged sequentially in size, and the gaps dRs in the third sub-pixel 112c are 4 μm (dR₁, dRₘᵢₙ), 8 μm (dR₂), dR₃, . . . arranged sequentially in size. Here, at least one of the gaps dBₙ (e.g., 7 μm (dB₂)) in the first sub-pixel 112a is different from at least one of the gaps dGₙ (e.g., 8 μm (dG₂)) in the second sub-pixel 112b and the gaps dRₙ (e.g., 8 μm (dR₂)) in the third sub-pixel 112c. The gap dBₙ (e.g., 7 μm (dB₂)) is the first different gap dB which is different from the other two gaps dGₙ and dRₙ when the gaps are arranged firstly from the minimum gaps dB₁, dG₁, and dR₁. Therefore, the gap dBₙ may also be referred to as the first different gap dBₙ, and the other two gaps dG and dR that are compared to the first different gap dBₙ may be referred to as the gaps dGₙ and dRₙ.

According to the formula E=V/d, i.e., the magnitude of an electric field (E) is inversely proportional to a distance (d) between two electrodes (and V refers to a voltage drop across the two electrodes), given the same voltage, the magnitude of the electric field generated by the first sub-pixel 112a may, through adjustment of the gaps dB in the first sub-pixel 112a, be greater than the magnitude of the electric field generated by the second sub-pixel 112b and greater than the magnitude of the electric field generated by the third sub-pixel 112c by about 10% to 15%. The N^{th} gap dRₙ in the third sub-pixel 112c is equal to the N^{th} gap dGₙ in the second sub-pixel 112b, and (1/dBₙ)≧[(1/dRₙ)*1.1]. For instance, the first sub-pixel 112a has two kinds of gaps dBs that are 4 μm (i.e., dBₘ=dBₘᵢₙ) and 7 μm (i.e., dBₙ); the second sub-pixel 112b has two kinds of gaps dGs that are 4 μm (i.e., dGₘ=dGₘᵢₙ) and 8 μm (i.e., dGₙ); the third sub-pixel 112c has two kinds of gaps dRs that are 4 μm (i.e., dRₘ=dRₘᵢₙ) and 8 μm (i.e., dRₙ). Here, dRₙ=dGₙ=8 um and dBₙ=7 um, which satisfies the condition “(1/dBₙ≧[(1/dRₙ)*1.1]”. In another embodiment of the invention, for instance, the first sub-pixel 112a has three kinds of gaps dBs that are 4 μm (i.e., dBₘᵢₙ), 7 μm (i.e., dBₙ), and 8 μm (i.e., dBₘ); the second sub-pixel 112b has two kinds of gaps dGs that are 4 μm (i.e., dGₘ=dGₘᵢₙ) and 8 μm (i.e., dGₙ); the third sub-pixel 112c has two kinds of gaps dRs that are 4 μm (i.e., dRₘ=dRₘᵢₙ) and 8 μm (i.e., dRₙ). Here, dRₙ=dGₙ=8 um and dBₙ=7 um, which satisfies the condition “(1/dBₙ)≧[(1/dRₙ)*1.1]”. Examples I to VIII are shown in the following Table 1. In these examples, the gap dGₙ is equal to the gap dRₙ, and thus the relations among the gaps dBₙ, dGₙ, and dRₙ are represented by the formula (1/dBₙ)≧[(1/dRₙ)*1.1]. In Table 1, the order dₘᵢₙ, dₙ, and dₘ may be changed to the order dₘᵢₙ, dₘ, and dₙ.

TABLE 1

| Examples | | dₘᵢₙ(μm) | dₙ(μm) | dₘ(μm) |
|---|---|---|---|---|
| I | dB | 4(dBₘᵢₙ) | 7(dBₙ) | 4(dBₘᵢₙ = dBₘ) |
| | dG | 4(dGₘᵢₙ) | 8(dGₙ) | 4(dGₘᵢₙ = dGₘ) |
| | dR | 4(dRₘᵢₙ) | 8(dRₙ) | 4(dRₘᵢₙ = dRₘ) |
| II | dB | 4(dBₘᵢₙ) | 7(dBₙ) | 11(dBₘᵢₙ < dBₘ) |
| | dG | 4(dGₘᵢₙ) | 8(dGₙ) | 12(dGₘᵢₙ < dGₘ) |
| | dR | 4(dRₘᵢₙ) | 8 (dRₙ) | 12(dRₘᵢₙ < dRₘ) |
| III | dB | 4(dBₘᵢₙ) | 7(dBₙ) | 8 (dBₘᵢₙ < dBₘ) |
| | dG | 4(dGₘᵢₙ) | 8(dGₙ) | 4(dGₘᵢₙ = dGₘ) |
| | dR | 4(dRₘᵢₙ) | 8 (dRₙ) | 4(dRₘᵢₙ = dRₘ) |
| IV | dB | 4(dBₘᵢₙ) | 7(dBₙ) | 4(dBₘᵢₙ = dBₘ) |
| | dG | 4(dGₘᵢₙ) | 8(dGₙ) | 12(dGₘᵢₙ < dGₘ) |
| | dR | 4(dRₘᵢₙ) | 8(dRₙ) | 4(dRₘᵢₙ = dRₘ) |
| V | dB | 4(dBₘᵢₙ) | 7(dBₙ) | 12(dBₘᵢₙ < dBₘ) |
| | dG | 4(dGₘᵢₙ) | 8(dGₙ) | 12(dGₘᵢₙ < dGₘ) |
| | dR | 4(dRₘᵢₙ) | 8(dRₙ) | 4(dRₘᵢₙ = dRₘ) |
| VI | dB | 4(=dBₘᵢₙ) | 7(=dBₙ) | 4(dBₘᵢₙ = dBₘ) |
| | dG | 4(=dGₘᵢₙ) | 8(=dGₙ) | 4(dGₘᵢₙ = dGₘ) |
| | dR | 4(=dRₘᵢₙ) | 8(=dRₙ) | 12(dRₘᵢₙ < dRₘ) |
| VII | dB | 4(=dBₘᵢₙ) | 7(=dBₙ) | 12(dBₘᵢₙ < dBₘ) |
| | dG | 4(=dGₘᵢₙ) | 8(=dGₙ) | 4(dGₘᵢₙ = dGₘ) |
| | dR | 4(=dRₘᵢₙ) | 8(=dRₙ) | 12(dRₘᵢₙ < dRₘ) |
| VIII | dB | 4(=dBₘᵢₙ) | 7(=dBₙ) | 4(dBₘᵢₙ = dBₘ) |
| | dG | 4(=dGₘᵢₙ) | 8(=dGₙ) | 12(dGₘᵢₙ < dGₘ) |
| | dR | 4(=dRₘᵢₙ) | 8(=dRₙ) | 12(dRₘᵢₙ < dRₘ) |

The structures of the first, second, and third sub-pixels 112a, 112b, and 112c are further described hereinafter. Since the structures of the three sub-pixels are similar to one another in the present embodiment, only the structure of the first sub-pixel 112a is elaborated herein. The first sub-pixel 112a includes a scan line SL, a first data line DL1, a second data line DL2, a first active device T1, a second active device T2, a first pixel electrode 120a, a second electrode 130a, and a common line CL, for instance. The first data line DL1 intersects the scan line SL. The second data line DL2 intersects the scan line SL. The scan line SL is employed to drive the first active device T1 and the second active device T2. The first active device T1 is electrically connected to the first data line DL1, and the second active device T2 is electrically connected to the second data line DL2. The first pixel electrode 120a and the second pixel electrode 130a are located between the first data line DL1 and the second data line DL2, in which the first pixel electrode 120a is located adjacent to the first data line DL1 and the second pixel electrode 130a is located adjacent to the second data line DL2. In addition, the first pixel electrode 120a is electrically connected to the drain of the first active device T1 through a contact window (not shown), and the second pixel electrode 130a is electrically connected to the drain of the second active device T2 through a contact window (not shown). The common line CL is parallel to the scan line SL.

According to the present embodiment, each of the first, second, and third sub-pixel areas 104a, 104b, and 104c includes a main area (106a, 106b, and 106c) and a secondary area (108a, 108b, and 108c). The first, third, and fifth branches 122a, 122b, and 122c and the second, fourth, and sixth branches 132a, 132b, and 132c located respectively in the main areas 106a, 106b, and 106c extend toward a first direction D1, for instance. The first, third, and fifth branches 122a, 122b, and 122c and the second, fourth, and sixth branches 132a, 132b, and 132c located respectively in the secondary areas 108a, 108b, and 108c extend toward a second direction D2, for instance. The first direction D1 is different from the second direction D2. To be specific, in the present embodiment, each of the first, third, and fifth pixel electrodes 120a, 120b, and 120c includes a longitudinal connection portion 124 and two transverse connection portions 126 and 128, for instance. In the first sub-pixel 112a, for instance, the longitudinal connection portion 124 is located between the first branches 122a and the first data line DL1 and is substantially parallel to the first data line DL1. The two transverse connection portions 126 and 128 are connected to the longitudinal connection portion 124 and are substantially parallel to the scan line SL. Besides, the two transverse connection portions 126 and 128 are located adjacent to the scan line SL and to another scan line, respectively. In detail, some of the first branches 122a are connected to the longitudinal connection portion 124, and the other first branches 122a are connected to the two transverse connection portions 126 and 128. According to other embodiments of the invention, the number of the transverse connection portions 126 and 128 may be singular, so as to connect all of the first branches 122a together.

Each of the second, fourth, and sixth pixel electrodes 130a, 130b, and 130c includes a longitudinal connection portion 134 and a transverse connection portion 136, for instance. In the first sub-pixel 112a, for instance, the longitudinal connection portion 134 is located between the second branches 132a and the second data line DL2 and is substantially parallel to the second data line DL2. The transverse connection portion 136 is connected to the longitudinal connection portion 134 and is substantially parallel to the scan line SL and the common line CL, preferably, overlapped with the common line CL. Some of the second branches 132a are connected to the longitudinal connection portion 134, and the other second branches 132a are connected to the transverse connection portion 136.

Each transverse connection portion 136 divides the first, second, and third sub-pixels 112a, 112b, and 112c into two alignment areas, i.e. the main area (106a, 106b, and 106c) and the secondary area (108a, 108b, and 108c). The alignment area (106a, 106b, and 106c) is located between the transverse connection portion 136 and the scan line SL, and the other alignment area (108a, 108b, and 108c) is located between the transverse connection portion 136 and another adjacent scan line. The first, third, and fifth branches 122a, 122b, and 122c and the second, fourth, and sixth branches 132a, 132b, and 132c located in the alignment area (106a, 106b, and 106c) all extend in the first direction D1 and are alternately arranged in parallel, for instance. In addition, the first, third, and fifth branches 122a, 122b, and 122c and the second, fourth, and sixth branches 132a, 132b, and 132c located in the alignment area (108a, 108b, and 108c) all extend in the second direction D2 and are alternately arranged in parallel, for instance. To be specific, the first, third, and fifth branches 122a, 122b, and 122c and the second, fourth, and sixth branches 132a, 132b, and 132c located between the transverse connection portion 136 and the transverse connection portion 126 extend in the direction D1, and the first, third, and fifth branches 122a, 122b, and 122c and the second, fourth, and sixth branches 132a, 132b, and 132c located between the transverse connection portion 136 and the transverse connection portion 128 extend in the direction D2. The first direction D1 and the second direction D2 are not parallel to each other, such that the first, second, and third sub-pixels 112a, 112b, and 112c may achieve wide-viewing-angle display effects during image display.

In this embodiment, given the extension direction of the scan line SL serves as a basis line to conduct a clockwise measurement, the first direction D1 and the scan line SL may include a 45-degree angle therebetween, and the second direction D2 and the scan line SL may include a 135-degree angle therebetween. In other embodiments of the invention, the aforesaid included angles may be modified based on different design concepts, which should not be construed as a limitation of the invention. Besides, according to other embodiments, the first, third, and fifth pixel electrodes 120a, 120b, and 120c and the second, fourth, and sixth pixel electrodes 130a, 130b, and 130c may have other structures or shapes, for instance.

The display panel 100 described in the present embodiment is an in-plane switching (IPS) display panel, for instance, while the display panel 100 described in other embodiments may be a vertically arranged type IPS display panel, a vertically aligned (VA) display panel, or any other display panel.

In the present embodiment, at least one of the widths of the gaps in the first sub-pixel 112a (e.g., a blue light sub-pixel) are adjusted to be different from the widths of the gaps in the second sub-pixel 112b (e.g., a green light sub-pixel) and the widths of the gaps in the third sub-pixel 112c (e.g., a red light sub-pixel). Thereby, a gamma curve of the first sub-pixel 112a (e.g., the blue light sub-pixel) may be similar to a gamma curve of the second sub-pixel 112b (e.g., the green light sub-pixel) and a gamma curve of the third sub-pixel 112c (e.g., the red light sub-pixel) when an image displayed by said sub-pixels is observed at a side angle. As such, an issue that color temperature is not changed in a continuous fashion may be resolved when an image at different gray-scale levels is observed at a side angle, and the color shift (e.g., going bluish at a low gray-scale level, going reddish or greenish at a medium gray-scale level, and going greenish at a high gray-scale level) of an image viewed at a side angle in comparison with an image viewed at the front angle may be corrected. Consequently, the optical quality of an image displayed on the display panel at a side viewing is improved, and so the display quality of the display panel is ameliorated. In particular, the widths of the gaps in the pixel electrodes of the sub-pixels are adjusted in the present embodiment, which may be easily integrated into the existing manufacturing process and will not lead to a significant increase in the manufacturing costs of the display panel.

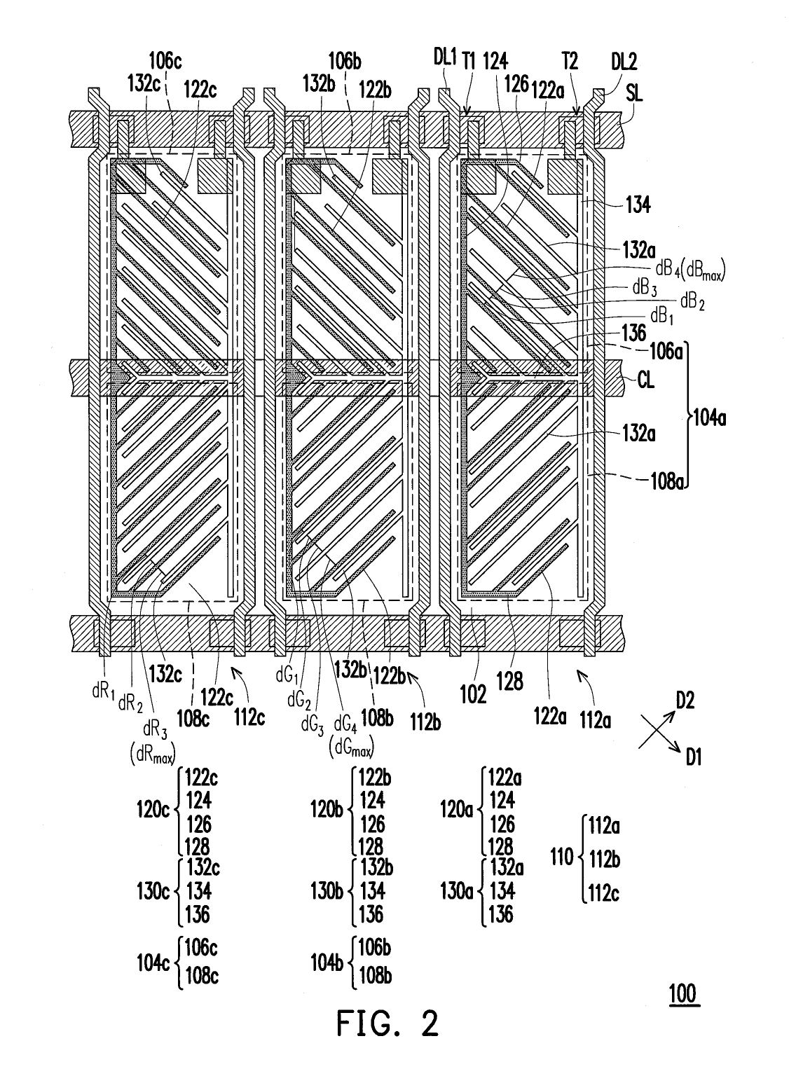

FIG. 2 is a schematic top view illustrating a display panel according to an embodiment of the invention. The structures of the sub-pixels in the present embodiment are substantially the same as those described in the first embodiment, while the main difference therebetween lies in the gap relations of the pixel electrodes in the sub-pixels. The difference will be described hereinafter, and the basic components of the pixel structure will be omitted. The display panel 100a includes a pixel structure 110a. The pixel structure 110a includes a first sub-pixel 112a, a second sub-pixel 112b, and a third sub-pixel 112c. The first sub-pixel 112a includes a first pixel electrode 120a and a second pixel electrode 130a. The first pixel electrode 120a includes a plurality of first branches 122a, the second pixel electrode 130a includes a plurality of second branches 132a, and the first branches 122a and the second branches 132a are alternately arranged in parallel. Here, a gap between one of the first branches 122a and an adjacent one of the second branches 132a is defined as dB, and the gaps dBs are not completely equal to one another and include maximum gap dBₘₐₓ. That is, the gaps dBs at least include the maximum gap dBₘₐₓ and a gap dBₘ that is smaller than the maximum gap dBₘₐₓ, and the two gaps dBₘₐₓ and dBₘ are sequentially arranged. In the present embodiment, there are four exemplary gaps dBs defined between the first pixel electrode 120a and the second pixel electrode 130a, i.e., the first gap dB₁, the second gap dB₂, the third gap dB₃, and the fourth gap dB₄ (i.e., the maximum gap dBₘₐₓ) that are sequentially arranged, and dB₁<dB₂<dB₃<dB₄(dBₘₐₓ). Here, the widths of the gaps dBs include 4 μm (dB₁), 7 μm (dB₂), 11 μm (dB₃), and 16 μm (dBₘₐₓ, dB₄), for instance.

The second sub-pixel 112b is disposed in a second sub-pixel area 104b and includes a third pixel electrode 120b and a fourth pixel electrode 130b. The third pixel electrode 120b includes a plurality of third branches 122b, the fourth pixel electrode 130b includes a plurality of fourth branches 132b, and the third branches 122b and the fourth branches 132b are alternately arranged in parallel. Here, a gap between one of the third branches 122b and an adjacent one of the fourth branches 132b is defined as dG, and the gaps dGs are not completely equal to one another and include maximum gap dGₘₐₓ. That is, the gaps dG at least include the maximum gap dGₘₐₓ and a gap dGₘ that is smaller than the maximum gap dGₘₐₓ, and the two gaps dGₘₐₓ and dGₘ are sequentially arranged. In the present embodiment, there are four exemplary gaps dGs defined between the third pixel electrode 120b and the fourth pixel electrode 130b, i.e., the first gap dG₁, the second gap dG₂, the third gap dG₃, and the fourth gap dG₄ (i.e., the maximum gap dGₘₐₓ) that are sequentially arranged, and dG₁<dG₂<dG₃<dG₄(dGₘₐₓ). Here, the gaps dGs include 4 μm (dG₁), 8 μm (dG₂), 12 μm (dG₃), and 14 μm (dGₘₐₓ, dG₄), for instance.

The third sub-pixel 112c is disposed in a third sub-pixel area 104c and includes a fifth pixel electrode 120c and a sixth pixel electrode 130c. The fifth pixel electrode 120c includes a plurality of fifth branches 122c, the sixth pixel electrode 130c includes a plurality of sixth branches 132c, and the fifth branches 122c and the sixth branches 132c are alternately arranged in parallel. Here, a gap between one of the fifth branches 122c and an adjacent one of the fifth branches 132c is defined as dR, and the gaps dRs are not completely equal to one another and include maximum gap dRₘₐₓ. That is, the gaps dR at least include the maximum gap dRₘₐₓ and a gap dRₘ that is smaller than the maximum gap dRₘₐₓ, and the two gaps dRₘₐₓ and dRₘ are sequentially arranged. In the present embodiment, there are three exemplary gaps dRs defined between the fifth pixel electrode 120c and the sixth pixel electrode 130c, i.e., the first gap dR₁, the second gap dR₂, and the third gap dR₃ (i.e., the maximum gap dRₘₐₓ) that are sequentially arranged, and dR₁<dR₂<dR₃(dRₘₐₓ). Here, the gaps dRs include 4 μm (dR₁), 8 μm (dR₂), and 12 μm (dRₘₐₓ, dR₃), for instance.

In the present embodiment, 12 μm (dRₘₐₓ)<14 μm (dGₘₐₓ)<16 μm (dBₘₐₓ), 5 μm>2 μm (dGₘₐₓ−dRₘₐₓ)>1 μm, and 5 μm>2 μm (dBₘₐₓ−dGₘₐₓ)>1 μm.

Even though the present embodiment discloses dRₘₐₓ<dGₘₐₓ<dBₘₐₓ, 5 μm>2 μm (dGₘₐₓ−dRₘₐₓ)>1 μm, and 5 μm>2 μm (dBₘₐₓ−dGₘₐₓ)>1 μm, the maximum gaps dRₘₐₓ, dGₘₐₓ, and dBₘₐₓ in the first sub-pixel 112a (e.g., a blue light sub-pixel), the second sub-pixel 112b (e.g., a green light sub-pixel), and the third sub-pixel 112c (e.g., a red light sub-pixel) may be adjusted to satisfy dRₘₐₓ=dGₘₐₓ<dBₘₐₓ, dGₘₐₓ−dRₘₐₓ=0 μm, and 5 μm>(dBₘₐₓ−dGₘₐₓ)>1 μm. For instance, the gaps dBs include 4 μm (dB₁), 7 μm (dB₂), and 16 μm (dBₘₐₓ, dB₃); the gaps dGs include 4 μm (dG₁), 8 μm (dG₂), and 12 μm (dGₘₐₓ, dG₃); the gaps dRs include 4 μm (dR₁), 8 μm (dR₂), and 12 μm (dRₘₐₓ, dR₃). Therefore, 12 μm (dRₘₐₓ)=12 μm (dGₘₐₓ)<16 μm (dBₘₐₓ), dGₘₐₓ−dRₘₐₓ=0 μm, and 5 μm>4 μm (dBₘₐₓ−dGₘₐₓ)>1 μm. In the previous embodiment, the gaps dGs may include 4 μm (dG₁), 8 μm (dG₂), 12 μm (dG₃), and 14 μm (dGₘₐₓ, dG₄), for instance. Besides, the gaps dBs in the previous embodiment may include 4 μm (dB₁), 7 μm (dB₂), 11 μm (dB₃), and 16 μm (dBₘₐₓ, dG₄), for instance.

Through adjustment of the maximum gaps dRₘₐₓ, dGₘₐₓ, and dBₘₐₓ in the first sub-pixel 112a (e.g., a blue light sub-pixel), the second sub-pixel 112b (e.g., a green light sub-pixel), and the third sub-pixel 112c (e.g., a red light sub-pixel), the conditions dRₘₐₓ≦dGₘₐₓ<dBₘₐₓ, 5 μm>(dGₘₐₓ−dRₘₐₓ)≧0 μm, and 5 μm>(dBₘₐₓ−dGₘₐₓ)>1 μm may be satisfied.

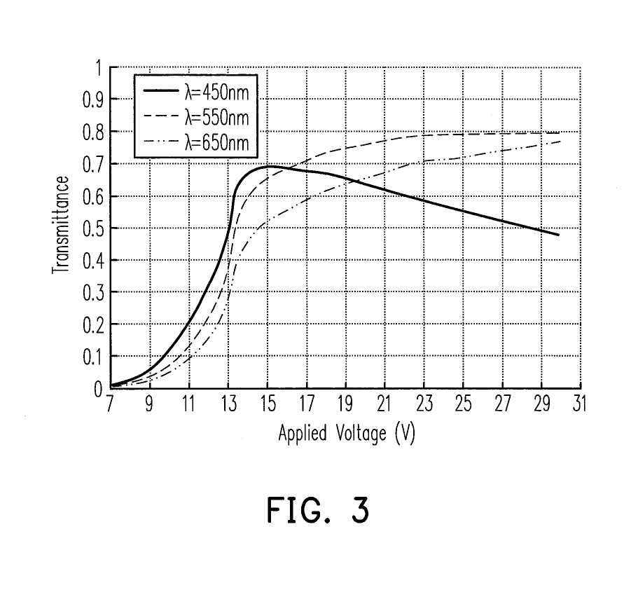

Since the transmittance is proportional to sin²(πΔn(V,d)d^{cell}/λ), and the wavelength (e.g., λ=650 nm) of the red light is longer than the wavelength (e.g., λ=550 nm) of the green light, the voltage-transmittance (V-T) curve is not apt to be saturated. As shown in FIG. 3, the blue light is saturated at approximately 15 V, the green light is saturated at approximately 20 V, and the red light is saturated at more than 30 V. By contrast, since the wavelength (e.g., λ=450 nm) of the blue light is shorter than the wavelength (e.g., λ=550 nm) of the green light, the V-T curve is apt to be saturated. As shown in FIG. 3, the blue light is saturated at approximately 15 V, the green light is saturated at approximately 20 V, and the red light is saturated at more than 30 V. Hence, the color washout caused by the Δn(V,d) difference among each sub-pixel may be compensated by adjusting the gaps of electrodes in the sub-pixels to satisfy dRₘₐₓ≦dGₘₐₓ<dBₘₐₓ; thereby, each sub-pixel may have similar light transmittance when driven by the same voltage, and the color shift (e.g., going bluish at a low gray-scale level, going reddish or greenish at a medium gray-scale level, and going greenish at a high gray-scale level) of an image viewed at a side angle in comparison with an image viewed at the front angle may be corrected. Consequently, the optical quality of an image displayed on the display panel at a side viewing may be improved, and so may the display quality of the display panel be ameliorated. In particular, the gaps in the pixel electrodes of the sub-pixels are adjusted in the present embodiment, which may be easily integrated into the existing manufacturing process and will not lead to a significant increase in the manufacturing costs of the display panel.

To sum up, as described in the embodiments of the invention, the widths of the gaps in the first sub-pixel (e.g., a blue light sub-pixel) are adjusted to be different from the widths of the gaps in the second sub-pixel (e.g., a green light sub-pixel) and the widths of the gaps in the third sub-pixel (e.g., a red light sub-pixel), or the conditions “dRₘₐₓ≦dGₘₐₓ<dBₘₐₓ”, “5 μm>(dGₘₐₓ−dRₘₐₓ)≧0 μm”, and “5 μm>(dBₘₐₓ−dGₘₐₓ)>1 μm” are satisfied. As a result, the adjusted gaps dBₘₐₓ, dGₘₐₓ, and dRₘₐₓ of electrodes in the sub-pixels allow the first, second, and third sub-pixels to have similar or substantially the same light transmittance when these sub-pixels are driven by the same voltage, so as to correct the color shift of an image displayed by the sub-pixels with different colors and viewed at a side angle. Further, the display quality of the display panel is ameliorated. In particular, the widths of the gaps in the pixel electrodes of the sub-pixels are adjusted in an embodiment of the invention, which may be easily integrated into the existing manufacturing process and will not lead to a significant increase in the manufacturing costs of the display panel.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display panel comprising:
a pixel structure comprising:
a first sub-pixel disposed in a first sub-pixel area and comprising a first pixel electrode and a second pixel electrode, the first pixel electrode comprising a plurality of first branches, the second pixel electrode comprising a plurality of second branches, the first branches and the second branches being alternately arranged in parallel, wherein a gap between one of the first branches and an adjacent one of the second branches is defined as dB, and the gaps dBs at least comprise a minimum gap dBₘᵢₙ and a N^{th} gap dBₙ sequentially arranged;
a second sub-pixel disposed in a second sub-pixel area, the second sub-pixel comprising a third pixel electrode and a fourth pixel electrode, the third pixel electrode comprising a plurality of third branches, the fourth pixel electrode comprising a plurality of fourth branches, the third branches and the fourth branches being alternately arranged in parallel, wherein a gap between one of the third branches and an adjacent one of the fourth branches is defined as dG, and the gaps dGs at least comprise a minimum gap dGₘᵢₙ and a N^{th} gap dGₙ sequentially arranged; and
a third sub-pixel disposed in a third sub-pixel area, the third sub-pixel comprising a fifth pixel electrode and a sixth pixel electrode, the fifth pixel electrode comprising a plurality of fifth branches, the sixth pixel electrode comprising a plurality of sixth branches, the fifth branches and the sixth branches being alternately arranged in parallel, wherein a gap between one of the fifth branches and an adjacent one of the sixth branches is defined as dR, the gaps dRs at least comprise a minimum gap dRₘᵢₙ and a N^{th} gap dRₙ sequentially arranged,
wherein the N^{th} gap dGₙ in the second sub-pixel is equal to the N^{th} gap dRₙ in the third sub-pixel, and (1/dBₙ)≧[(1/dRₙ)*1.1].

2. The display panel as recited in claim 1, wherein the first sub-pixel comprises a blue light sub-pixel, the second sub-pixel comprises a green light sub-pixel, and the third sub-pixel comprises a red light sub-pixel.

3. The display panel as recited in claim 1, wherein the gaps dBs of the first sub-pixel further comprises a M^{th} gap dBₘ, dBₘ≧dBₘᵢₙ, and the M^{th} gap dBₘ is adjacent to the N^{th} gap dBₙ.

4. The display panel as recited in claim 1, wherein the gaps dGs of the second sub-pixel further comprises a M^{th} gap dGₘ, dGₘ≧dGₘᵢₙ, and the M^{th} gap dGₘ is adjacent to the N^{th} gap dGₙ.

5. The display panel as recited in claim 1, wherein the gaps dRs of the third sub-pixel further comprises a M^{th} gap dRₘ, dRₘ≧dRₘᵢₙ, and the M^{th} gap dRₘ is adjacent to the N^{th} gap dRₙ.

6. The display panel as recited in claim 1, wherein the first sub-pixel area comprises a main area and a secondary area, the first branches and the second branches located in the main area extend toward a first direction, the first branches and the second branches located in the secondary area extend toward a second direction, and the first direction is different from the second direction.

7. The display panel as recited in claim 1, wherein the second sub-pixel area comprises a main area and a secondary area, the third branches and the fourth branches located in the main area extend toward a first direction, the third branches and the fourth branches located in the secondary area extend toward a second direction, and the first direction is different from the second direction.

8. The display panel as recited in claim 1, wherein the third sub-pixel area comprises a main area and a secondary area, the fifth branches and the sixth branches located in the main area extend toward a first direction, the fifth branches and the sixth branches located in the secondary area extend toward a second direction, and the first direction is different from the second direction.

9. The display panel as recited in claim 1, wherein the display panel is an in-plane switching display panel.

10. The display panel as recited in claim 1, wherein the display panel is a vertically arranged type in-plane switching display panel.

11. A display panel comprising:
a pixel structure comprising:
a first sub-pixel disposed in a first sub-pixel area, the first sub-pixel comprising a first pixel electrode and a second pixel electrode, the first pixel electrode comprising a plurality of first branches, the second pixel electrode comprising a plurality of second branches, the first branches and the second branches being alternately arranged in parallel, wherein a gap between one of the first branches and an adjacent one of the second branches is defined as dB, and the gaps dBs are not completely equal to one another and comprise a maximum gap dBₘₐₓ;
a second sub-pixel disposed in a second sub-pixel area, the second sub-pixel comprising a third pixel electrode and a fourth pixel electrode, the third pixel electrode comprising a plurality of third branches, the fourth pixel electrode comprising a plurality of fourth branches, the third branches and the fourth branches being alternately arranged in parallel, wherein a gap between one of the third branches and an adjacent one of the fourth branches is defined as dG, and the gaps dGs are not completely equal to one another and comprise a maximum gap dGₘₐₓ; and
a third sub-pixel disposed in a third sub-pixel area, the third sub-pixel comprising a fifth pixel electrode and a sixth pixel electrode, the fifth pixel electrode comprising a plurality of fifth branches, the sixth pixel electrode comprising a plurality of sixth branches, the fifth branches and the sixth branches being alternately arranged in parallel, wherein a gap between one of the fifth branches and an adjacent one of the sixth branches is defined as dR, the gaps dRs are not completely equal to one another and comprise a maximum gap dRₘₐₓ,
wherein dRₘₐₓ≦dGₘₐₓ<dBₘₐₓ, 5 μm>(dGₘₐₓ−dRₘₐₓ)≧0 μm, and 5 μm>(dBₘₐₓ−dGₘₐₓ)>1 μm.

12. The display panel as recited in claim 11, wherein the first sub-pixel comprises a blue light sub-pixel, the second sub-pixel comprises a green light sub-pixel, and the third sub-pixel comprises a red light sub-pixel.

13. The display panel as recited in claim 11, wherein the first sub-pixel area comprises a main area and a secondary area, the first branches and the second branches located in the main area extend toward a first direction, the first branches and the second branches located in the secondary area extend toward a second direction, and the first direction is different from the second direction.

14. The display panel as recited in claim 11, wherein the second sub-pixel area comprises a main area and a secondary area, the third branches and the fourth branches located in the main area extend toward a first direction, the third branches and the fourth branches located in the secondary area extend toward a second direction, and the first direction is different from the second direction.

15. The display panel as recited in claim 11, wherein the third sub-pixel area comprises a main area and a secondary area, the fifth branches and the sixth branches located in the main area extend toward a first direction, the fifth branches and the sixth branches located in the secondary area extend toward a second direction, and the first direction is different from the second direction.

16. The display panel as recited in claim 11, wherein the display panel is an in-plane switching display panel.

17. The display panel as recited in claim 11, wherein the display panel is a vertically arranged type in-plane switching display panel.
